(19) United States
(12) Patent Application Publication
(10) Pub. No.: US 2011/0129722 A1
(43) Pub. Date: Jun. 2, 2011

(54) FLAT SECONDARY BATTERY AND METHOD OF MANUFACTURING THE SAME

(76) Inventor: Tetsuya Yoneda, Osaka (JP)

(21) Appl. No.: 13/003,379

(22) PCT Filed: Jul. 2, 2009
(86) PCT No.: PCT/JP2009/062127

§ 371 Date: Jan. 10, 2011

(30) Foreign Application Priority Data
Jul. 9, 2008 (JP) 2008-179073

(51) Int. Cl. H01M 10/0585; H01M 6/02

(52) U.S. Cl. 429/162; 29/623.2

(57) ABSTRACT

A flat secondary battery comprising: a positive electrode plate; a negative electrode plate opposed to the positive electrode plate; an electrolytic solution being present between the electrode plates; a separator interposed between the electrode plates; and a covering material for sealing the electrolytic solution, wherein
the positive electrode plate includes: a positive-electrode current-collector sheet whose peripheral area has a bonding area bonded to a peripheral area of the separator; and a positive-electrode active-material layer laminated on a non-bonding area of one surface or both surfaces of the positive-electrode current-collector sheet,
the negative-electrode plate includes: a negative-electrode current-collector sheet whose peripheral area has a bonding area bonded to the peripheral area of the separator; and a negative-electrode active-material layer laminated on a non-bonding area of one surface or both surfaces of the negative-electrode current-collector sheet and having a sufficient size to cover the positive-electrode active-material layer, and
the peripheral areas of both surfaces of the separator are bonded to the bonding areas of the positive-electrode current-collector sheet and the negative-electrode current-collector sheet to maintain a state in which an area of the negative-electrode active-material layer entirely covers an area of the positive-electrode active-material layer so that a battery module is formed.

### TECHNICAL FIELD

The present invention relates to a flat secondary battery and a method of manufacturing the same.

### BACKGROUND ART

As conventional secondary batteries, there have been cylindrical and flat secondary batteries.

In a cylindrical secondary battery, typically, one band-shaped positive-electrode plate and one band-shaped negative-electrode plate are stacked with a band-shaped separator therebetween, and the stacked plates are spirally wound, so that an electrode group is formed. In this case, there are eight pointed corners in the electrode group, namely, four pointed corners of the positive-electrode plate and four pointed corners of the negative-electrode plate.

On the other hand, as a flat secondary battery of a quadrangular type or a laminated sealing type, Prior Art 1 is known in which, with a strip-shaped positive-electrode plate or a negative-electrode plate contained in a bag-like separator, the plurality of positive-electrode plates and the plurality of negative-electrode plates are alternately laminated, so that a battery group is formed (for example, see Patent Document 1).

In these secondary batteries, the positive-electrode plate has a positive-electrode active-material layer, the negative-electrode plate has a negative-electrode active-material layer, and the negative-electrode active-material layer is somewhat larger than the positive-electrode active-material layer so that a whole area of the positive-electrode active-material layer overlaps an opposing area of the negative-electrode active-material layer.

For example, in a case where the positive-electrode active-material layer has an area that does not overlap the negative-electrode active-material layer during charging and discharging in a lithium-ion secondary battery, part of Li ions emitted from the positive-electrode active-material layer are not stored in the negative-electrode active-material layer to result in metal deposition on a negative-electrode current collector. Consequently, metal deposition leading to a capacitance decrease occurs. To prevent such a problem, the whole area of the positive-electrode active-material layer overlaps the opposing area of the negative-electrode active-material layer as mentioned above.

The flat secondary battery of Prior Art 1 necessarily has an increased number of electrodes stored in the inside thereof compared to the cylindrical secondary battery. As the number of stored electrodes increases, the number of pointed corners of the electrodes increases. Therefore, the flat secondary battery has a problem in that a risk of occurrence of internal short-circuiting is increased as a result of damage to the bag-like separator by the pointed corner when a vibration or an impact from the outside is received.

For example, in a case of a laminated flat secondary battery having 10 positive-electrode plates and 10 negative-electrode plates, the total number of pointed corners of the electrodes is as much as 80. Therefore, it is easily supposed that a rate of occurrence of damage to a separator and a rate of occurrence of internal short-circuiting, which goes along therewith, are ten times of those of the cylindrical secondary battery.

To prevent damage to the bag-like separator by the pointed corner of the electrode and internal short-circuiting, a flat secondary battery of Prior Art 2 has been proposed in which outer peripheral portions of two separators are fused or bonded to both surfaces of an outer peripheral portion of a positive-electrode plate (for example, see Patent Document 2).

### PRIOR ART DOCUMENTS

### Patent Documents

Patent Document 1: Japanese Unexamined Patent Publication No. 2003-346765
Patent Document 2: Japanese Unexamined Patent Publication No. 06-36801

### SUMMARY OF THE INVENTION

### Problems to be Solved by the Invention

The inventor made drop tests and charge and discharge cycle tests of flat lithium ion secondary batteries of Prior Arts 1 and 2. There were some cases where explosion and ignition or abnormal heat generation occurred.

An investigation was made about causes of these phenomena. With the flat secondary battery of Prior Art 1, as described above, pointed corners of the positive-electrode plate broke through the separator to bring the positive-electrode plate into direct contact with the negative-electrode plate, and as a result, internal short-circuiting occurred. It was confirmed that such occurrence was the cause of the phenomena.

Further, the inventor found, as the above-mentioned cause common to the flat lithium ion secondary batteries of Prior Arts 1 and 2, that there were some cases where dendrites occurred inside a battery, and the dendrites broke through the separator to cause internal short-circuiting.

After the inventor investigated this cause, it was confirmed that an impact and a vibration resulting from dropping the battery caused a relative position shift between the positive-electrode active-material layer and the negative-electrode active-material layer, and therefore the positive-electrode active-material layer had a portion that did not overlap the negative-electrode active-material layer serving as an acceptor of lithium ions, as a result of which, lithium metal was deposited on a negative-electrode current collector.

The present invention is made in view of such problems, and an object of the invention is to provide a flat secondary battery in which a failure due to internal short-circuiting is less likely to occur even when the battery receives a vibration and an impact, and a method of manufacturing the same.

### Means for Solving the Problems

The present invention therefore provides a flat secondary battery comprising: a positive electrode plate; a negative electrode plate opposed to the positive electrode plate; an electrolytic solution being present between the electrode plates; a separator interposed between the electrode plates; and a covering material for sealing the electrolytic solution, wherein

the positive electrode plate includes: a positive-electrode current-collector sheet whose peripheral area has a bonding area bonded to a peripheral area of the separator; and a positive-electrode active-material layer laminated on a non-bonding area of one surface or both surfaces of the positive-electrode current-collector sheet,

the negative-electrode plate includes: a negative-electrode current-collector sheet whose peripheral area has a bonding area bonded to the peripheral area of the separator; and a negative-electrode active-material layer laminated on a non-bonding area of one surface or both surfaces of the negative-electrode current-collector sheet and having a sufficient size to cover the positive-electrode active-material layer, and

the peripheral areas of both surfaces of the separator are bonded to the bonding areas of the positive-electrode current-collector sheet and the negative-electrode current-collector sheet to maintain a state in which an area of the negative-electrode active-material layer entirely covers an area of the positive-electrode active-material layer so that a battery module is formed.

According to another aspect of the present invention, there is provided a method of manufacturing a flat secondary battery, comprising the steps of:

(A) laminating a positive-electrode active-material layer on a non-bonding area, which does not bond to a separator, of one surface or both surfaces of a positive-electrode current-collector sheet to form a positive electrode plate, and attaching a lead plate to the positive-electrode current-collector sheet;

(B) laminating a negative-electrode active-material layer on a non-bonding area, which does not bond to the separator, of one surface or both surfaces of a negative-electrode current-collector sheet to form a negative electrode plate, and attaching a lead plate to the negative-electrode current-collector sheet;

(C) bonding a bonding area in a peripheral area of the positive-electrode current-collector sheet and the negative-electrode current-collector sheet each to peripheral areas of both surfaces of the separator to form a battery module; and

(D) enclosing the battery module in a covering material having an electrolytic solution inlet in a state to expose an end of each lead plate to the outside of the covering material, injecting an electrolytic solution into the covering material through the electrolytic solution inlet, and sealing the electrolytic solution inlet.

### Effects of Invention

According to the present invention, it is possible to obtain a flat secondary battery excellent in impact resistance such that, even with a vibration, an impact and the like during a distribution course and in a usage environment, there is no internal short-circuiting due to disturbance of an electrode laminated structure and damage to a separator by a pointed corner of an electrode.

### BRIEF DESCRIPTION OF THE DRAWINGS

FIG. 1 is a perspective view showing Embodiment 1 of a flat secondary battery of the present invention.

FIG. 2 is a schematic sectional view showing an internal laminated structure in the flat secondary battery of Embodiment 1 of the present invention.

FIGS. 3(A) to 3(E) are process explanatory views each showing part of a process of manufacturing the flat secondary battery in Embodiment 1 of the present invention.

FIGS. 4(A) and 4(B) are process explanatory views each showing part of a process of manufacturing a flat secondary battery in Embodiment 2 of the present invention.

FIGS. 5(A) to 5(E) are process explanatory views each showing part of a process of manufacturing a flat secondary battery in Embodiment 3 of the present invention.

FIGS. 6(A) to 6(E) are process explanatory views each showing part of a process of manufacturing a flat secondary battery in Embodiment 5 of the present invention.

FIGS. 7(A) to 7(E) are process explanatory views each showing part of a process of manufacturing a flat secondary battery in Embodiment 7 of the present invention.

FIG. 8 is a schematic sectional view showing an internal laminated structure in a flat secondary battery of Embodiment 9 of the present invention.

FIGS. 9(A) to 9(C) are process explanatory views each showing part of a process of manufacturing the flat secondary battery in Embodiment 9 of the present invention.

FIGS. 10(A) to 10(C) are schematic views each showing an inside of a battery of Comparative Example 1 after being tested.

### MODES FOR CARRYING OUT THE INVENTION

A flat secondary battery of the present invention comprising: a positive electrode plate; a negative electrode plate opposed to the positive electrode plate; an electrolytic solution being present between the electrode plates; a separator interposed between the electrode plates; and a covering material for sealing the electrolytic solution, wherein

the positive electrode plate includes: a positive-electrode current-collector sheet whose peripheral area has a bonding area bonded to a peripheral area of the separator; and a positive-electrode active-material layer laminated on a non-bonding area of one surface or both surfaces of the positive-electrode current-collector sheet,

the negative-electrode plate includes: a negative-electrode current-collector sheet whose peripheral area has a bonding area bonded to the peripheral area of the separator; and a negative-electrode active-material layer laminated on a non-bonding area of one surface or both surfaces of the negative-electrode current-collector sheet and having a sufficient size to cover the positive-electrode active-material layer, and

the peripheral areas of both surfaces of the separator are bonded to the bonding areas of the positive-electrode current-collector sheet and the negative-electrode current-collector sheet to maintain a state in which an area of the negative-electrode active-material layer entirely covers an area of the positive-electrode active-material layer so that a battery module is formed.

This flat secondary battery is termed a quadrangular secondary battery or a laminated sealing secondary battery, and has a basic structure as described above in which a positive-electrode plate and a negative-electrode plate are alternately disposed with a separator therebetween, and the battery in a state where an electrolytic solution exists between both the electrode plates is sealed with a covering material. Therefore, the flat secondary battery is applicable to flat secondary batteries each having the above-mentioned basic structure, such as lithium ion secondary batteries, nickel-metal hydride rechargeable batteries, and nickel-cadmium rechargeable batteries.

This flat secondary battery is also applicable to a structure in which one or a plurality of battery modules each including a positive-electrode plate and a negative-electrode plate with a separator therebetween are stacked.

Hereinafter, the structure and elements of the flat secondary battery of the present invention are described.

### (Positive-Electrode Plate and Negative-Electrode Plate)

The positive-electrode plate and the negative-electrode plate each have a structure in which, as described above, an active material layer of each electrode is included in a non-bonding area (active material formation region) of one surface or both surfaces of a current collector sheet of each electrode, and a component material suitable for each electrode can be used.

### <Current Collector Sheet>

The current collector sheet is not particularly limited as long as it causes no chemical reaction in a flat secondary battery to be formed, such as a lithium ion secondary battery, a nickel-metal hydride rechargeable battery or a nickel-cadmium rechargeable battery.

Hereinafter, a current collector sheet of a lithium ion secondary battery is specifically described as a representative example of the flat secondary battery of the present invention.

As a material for a positive-electrode current collector sheet, for example, aluminum, aluminum alloys, stainless steels, nickel, titanium and carbon are mentioned, and further materials in which the surface of aluminum or a stainless steel is treated with carbon, nickel, titanium or silver are used. In particular, aluminum or aluminum alloys are preferable. Further, materials in which the surfaces of such materials are oxidized may be used. Alternatively, a positive-electrode current collector sheet obtained by forming the above-mentioned metal film (e.g., Al film) on the surface of a film made of at least one kind of a resin material among polypropylene, polyethylene, polyethylene terephthalate, nylon, polyamide and polyimide by a technique including any one of vapor deposition, plating and sputtering may be used.

As a material for a negative-electrode current collector sheet, for example, copper, copper alloys, stainless steels, nickel, titanium, aluminum and carbon are mentioned, and further materials in which the surface of copper or a stainless steel is treated with carbon, nickel, titanium or silver, Al—Cu alloys and the like are used. In particular, copper or copper alloys are preferable. Further, materials in which the surfaces of such materials are oxidized may be used. Alternatively, a negative-electrode current collector sheet obtained by forming the above-mentioned metal film (e.g., Cu film) on the surface of a film made of at least one kind of a resin material among polypropylene, polyethylene, polyethylene terephthalate, nylon, polyamide and polyimide by a technique including any one of vapor deposition, plating and sputtering may be used.

The thickness of the current collector sheet of each electrode is preferably from 0.5 to 10 μm, and more preferably from about 2 to 5 μm, in terms of resistance in battery characteristics.

### <Active Material Layer>

For the active material layer, there is used a known material that is suitable for a laminated-type secondary battery to be formed, such as a lithium ion secondary battery, a nickel-metal hydride rechargeable battery or a nickel-cadmium rechargeable battery.

Hereinafter, an active material layer of the lithium ion secondary battery as a representative example of the flat secondary battery of the present invention is specifically described.

In the case of a lithium ion secondary battery, an oxide containing lithium can be used as the positive active material. For example, complex oxides, sulfides or selenides of titanium, molybdenum, copper, niobium, vanadium, manganese, chromium, nickel, iron, cobalt or phosphorus and lithium, and the like are preferable. Specifically, one or more of LiMnO₂, LiMn₂O₄, LiNiO₂, LiCoO₂, LiCrO₂, LiFeO₂, LiVo₂ and LiMPO₄ (M is one or more kinds of elements selected from Co, Ni, Mn and Fe) can be used singly or in combination of a plurality of kinds.

Also, as the negative active material, at least one or more of graphite-based materials such as natural graphites, artificial graphites and highly crystalline graphites, amorphous carbon-based materials, and metal oxides such as Nb₂O₅ and LiTiO₄ can be used singly or in combination of a plurality of kinds.

Further, a conductivity agent, a binder, a filler, a dispersing agent, an ion conductivity agent and a pressure fortifier to be described later, and various kinds of other additives can be used for the positive and negative-electrode active-material layers.

The active material layer can be formed, for example, in such a way that a mixture of an active material and various kinds of additives is applied in the active material formation region of one surface or both surfaces of a current collector sheet, the current collector sheet is dried at a temperature (e.g., about 100° C. or less) at which deformation or fusion of the current collector sheet does not occur, and the current collector sheet is compression molded by a roll press.

The thicknesses of the positive and negative-electrode active-material layers are suitably from about 20 to 150 μm, and preferably from about 50 to 100 μm.

The conductivity agent is not particularly limited if it is an electronic conductive material that is usually used as a battery material and causes no chemical reaction in a battery in which the conductive material is included. For example, graphites such as natural graphites (vein graphite, flake graphite, amorphous graphite and so on) and artificial graphites, carbon blacks such as acetylene black, ketjen black, channel black, furnace black, lamp black and thermal black, conductive fibers such as a vapor-phase growth graphite fiber (VGCF), a carbon fiber and a metal fiber, metal powders of copper, nickel, aluminum, silver and so on, conductive whiskers of a zinc oxide, potassium titanate and so on, conductive metal oxides such as a titanium oxide and organic conductive materials such as a polyphenylene derivative can be used singly or as a mixture thereof. Among these conductivity agents, acetylene black, VGCF, and the combined use of a graphite with acetylene black are particularly preferred.

The binder can be used if it is generally used as a battery material and is used as one of polysaccharides, thermoplastic resins and polymers with rubber elasticity, or a mixture thereof. As preferred examples thereof, a starch, a polyvinyl alcohol, a carboxymethylcellulose, a hydroxypropylcellulose, a regenerated cellulose, a diacetylcellulose, a polyvinyl chloride, a polyvinylpyrrolidone, a polytetrafluoroethylene, a polyvinylidene fluoride, a polyethylene, a polypropylene, ethylene-propylene-diene terpolymer (EPDM), a sulfonated EPDM, styrene-butadiene rubber, polybutadiene, fluororubber and a polyethylene oxide can be mentioned.

The filler is generally used as a battery material, and is not particularly limited if it is a fibrous material that causes no chemical reaction in a lithium secondary battery in which the fibrous material is included. For example, fibers such as olefin-based polymers, such as a polypropylene and a polyethylene, glass and carbon can be used.

As the ion conductivity agents, for example, polyethylene oxide derivatives or polymers containing these derivatives, polypropylene oxide derivatives, polymers containing polypropylene oxide derivatives, phosphoric acid ester polymers and the like, which are generally known as inorganic and organic solid electrolytes can be used.

The pressure fortifier is a compound that increases the internal pressure of a battery, and a carbonate can be mentioned as a representative example thereof.

### (Lead Plate)

The lead plate is a plate that connects a current collector sheet of each of positive and negative electrodes with an electrode terminal. The material therefor is not particularly limited if it has a conductivity, and a material for forming a current collector sheet can be used. In particular, it is preferable that the same material as that for a positive-electrode current collector sheet be used for a positive-electrode lead plate, and the same material as that for a negative-electrode current collector sheet be used for a negative-electrode lead plate.

The thickness of a lead plate for each of positive and negative electrodes is suitably from about 50 to 300 μm, and preferably from about 80 to 200 μm.

### (Separator)

In the present invention, the separator has a function of preventing physical contact and electrical contact of the positive-electrode plate and the negative-electrode plate, and a function of preventing a relative position shifts between the positive-electrode plate and the negative-electrode plate.

As described above, the peripheral areas of both surfaces (one surface and the other surface) of the separator are bonded to bonding areas in the peripheral areas of the positive-electrode current collector sheet and the negative-electrode current collector sheet, so that the function of preventing a position shift is expressed. At this point, to enhance the effect and strength of preventing a position shift, a plurality of bonding locations (bonding areas) between the positive-electrode current collector sheet and the separator and a plurality of bonding locations (bonding areas) between the negative-electrode current collector sheet and the separator are preferably provided.

Here, the peripheral area of the current collector sheet of each of positive and negative electrodes means the vicinity of each side of four sides of the current collector sheet in the case where the current collector sheet is quadrangular. Also, in the case where there is one bonding location, the whole or part of one side of the current collector sheet means the bonding area; in the case where there are a plurality of bonding locations, the whole or part of two or more sides of the current collector sheet means the bonding area.

Note that a bonded form between the separator and current collector sheets of positive and negative electrodes are to be described in detail later.

As the separator used in the present invention, for example, a microporous film made of a synthetic resin of an olefin-based resin such as a polyethylene, a polypropylene or a polyester can be used singly or in combination, and it is also possible to use an inexpensive separator, such as a nonwoven fabric, as necessary. Also, the use of a separator exhibiting excellent in heat resistance, which is made of, for example, an aramid resin, is preferable because it improves safety.

The thickness of the separator is suitably from about 5 to 100 μm, and preferably from about 10 to 30 μm. The percentage of voids of the separator is suitably from about 30 to 90%, and preferably from about 40 to 80%.

Note that if the thickness of the separator is less than 5 μm, the separator is short of mechanical strength to cause internal short-circuiting of a battery. Therefore, this is not preferable. If the thickness is larger than 100 μm, the distance between positive and negative electrodes is long to make the internal resistance of the battery high. Therefore, this is not preferable.

Also, if the percentage of voids of the separator is lower than 30%, the content of an electrolytic solution decreases to make the internal resistance of the battery high. Therefore, this is not preferable. If the percentage is higher than 90%, the positive electrode and the negative electrode come into physical contact with each other to cause internal short-circuiting of the battery. Therefore, this is not preferable.

Here, the thickness and the percentage of voids of the separator mean values obtained by measuring the thickness of the separator with a micrometer and measuring the weight of the separator with an electronic balance, calculating the density of the separator, and measuring the ratio with respect to the true density of the resin.

### (Electrolytic Solution)

For an electrolytic solution, there is used a known material that is suitable for a laminated-type secondary battery to be formed, such as a lithium ion secondary battery, a nickel-metal hydride rechargeable battery or a nickel-cadmium rechargeable battery.

Hereinafter, an electrolytic solution for a lithium ion secondary battery as a representative example of the laminated-type secondary battery of the present invention is specifically described.

As the electrolytic solution, there is used a nonaqueous electrolytic solution containing a lithium salt.

As lithium salts for use in a lithium ion secondary battery, lithium salts such as lithium borofluoride (LiBF₄), lithium hexafluorophosphate (LiPF₆), lithium trifluoromethane sulfonate (LiCF₃SO₃), lithium trifluoroacetate (LiCF₃COO) and lithium bis(trifluoromethane sulfone)imide (LiN(CF₃SO₂)₂) are mentioned, and can be used singly or a mixture of two kinds or more. The salt concentration of a nonaqueous electrolyte is preferably from 0.5 to 3 mol/L.

Also, instead of a nonaqueous electrolytic solution, there can be used a gel electrolyte in which the above-mentioned electrolytic solution is held in a polymer matrix. A polymer matrix that has a copolymer of a polyethylene oxide and a polypropylene oxide as its basic structure and in which a compound having polyfunctional acrylate at its end is cross-linked is preferable. The use of the gel electrolyte provides a battery with a strong crosslinked structure as compared to a physically cross-linked gel, and therefore the battery has fewer problems, such as seeping of a nonaqueous electrolytic solution from the gel, which increases the reliability of the battery.

As solvents for a nonaqueous electrolyte used in the present invention, cyclic carbonates such as propylene carbonate (PC), ethylene carbonate (EC) and butylene carbonate, chain carbonates such as dimethyl carbonate (DMC), diethyl carbonate (DEC), ethyl methyl carbonate (EMC) and dipropyl carbonate, lactones such as γ-butyrolactone (hereinafter sometimes referred to as “GBL”) and γ-valerolactone, furans such as tetrahydrofuran, 2-methyltetrahydrofuran, ethers such as diethyl ether, 1,2-dimethoxy-ethane, 1,2-diethoxyethane, ethoxymethoxyethane and dioxane, dimethyl sulfoxide, sulfolane, methylsulfolane, acetonitrile, methyl formate, methyl acetate, and the like are mentioned. These can be used singly or as a mixture of two kinds or more. In particular, containing γ-butyrolactone (GBL) is preferable. Also, for the purpose of safety improvement, it is possible to use an ionic liquid. Further, in order to form a good coating on an electrode or to improve safety of charging and discharging, vinylene carbonate (VC) and cyclohexylbenzene (CHB) may be added.

### (Covering Material)

As a covering material (battery case) used in the present invention, there can be used a sealing bag that is formed of, for example, a film of iron, stainless steel, aluminum or an aluminum foil laminated with a resin in a quadrangular cylindrical shape or a thin, flat cylindrical shape, or a can made of metal.

With reference to the drawings, various embodiments of the flat secondary battery of the present invention are specifically described below. It should be noted that elements included in the flat secondary battery have been described above and therefore detailed descriptions thereof are omitted, and the structure and the assembly of a battery module are mainly described in detail.

### Embodiment 1

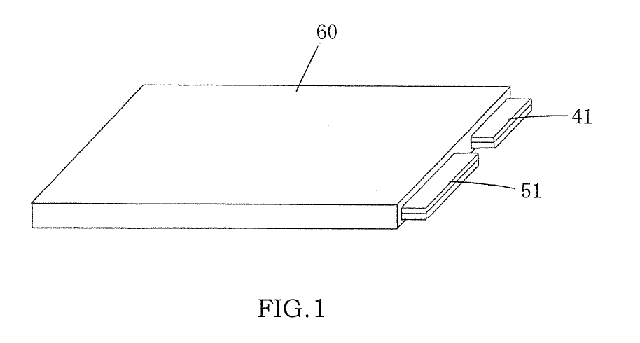

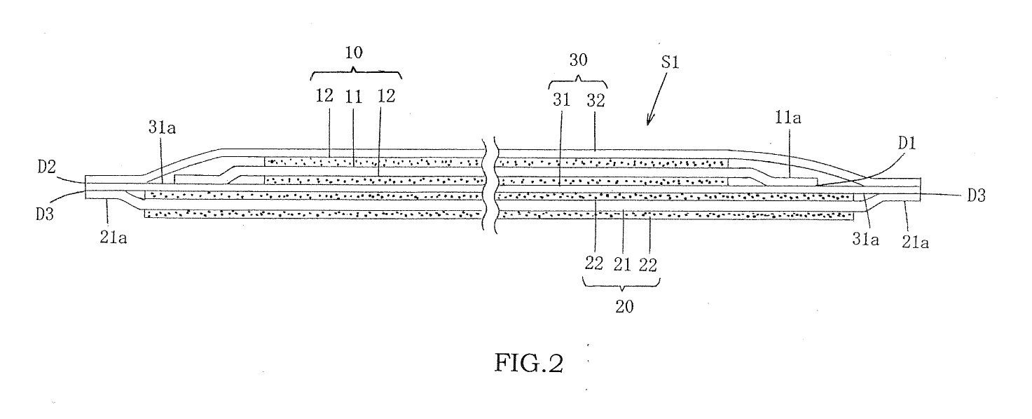

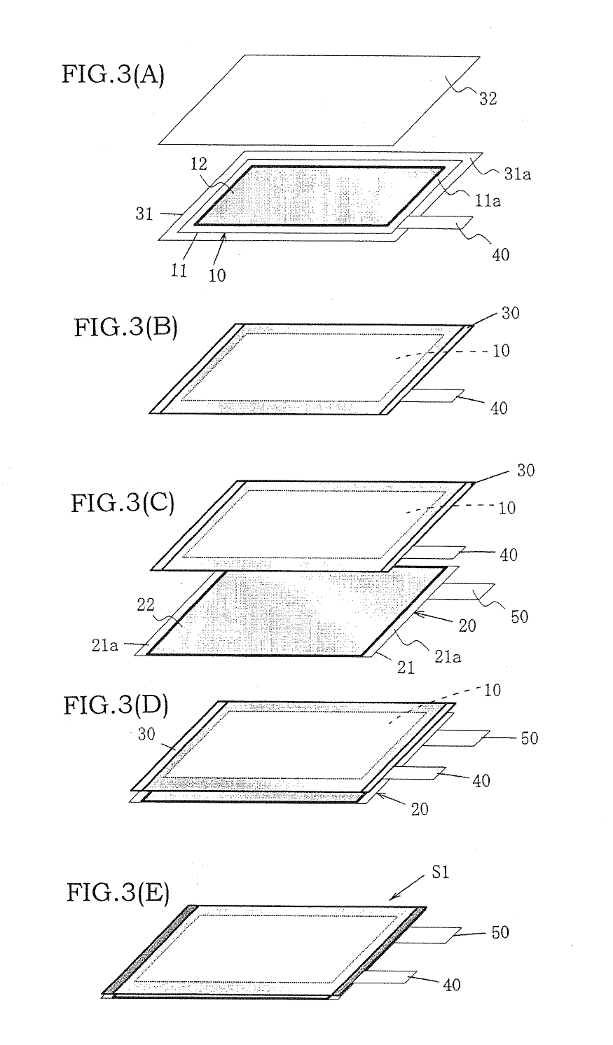

FIG. 1 is a perspective view showing Embodiment 1 of a flat secondary battery of the present invention. FIG. 2 is a schematic sectional view showing an internal laminated structure in the flat secondary battery of Embodiment 1. FIGS. 3(A) to 3(E) are process explanatory views each showing part of a process of manufacturing the flat secondary battery of Embodiment 1.

This laminated-type secondary battery includes one positive-electrode plate 10, one negative-electrode plate 20, a bag-like separator 30 for preventing physical and electrical contact of the positive-electrode plate 10 and the negative-electrode plate 20, a positive-electrode lead plate 40 electrically connected to the positive-electrode plate 10, a positive-electrode terminal plate 41 bonded to the positive-electrode lead plate 40, a negative-electrode lead plate 50 electrically connected to the negative-electrode plate 20, a negative-electrode terminal plate 51 bonded to the negative-electrode lead plate 50, a covering material 60, and an electrolytic solution (not shown) that is injected into the inside the covering material 60.

The positive-electrode plate 10 has a rectangular positive-electrode current collector sheet 11, and a positive-electrode active-material layer 12 laminated in a rectangular shape in the active material formation region of both surfaces of the positive-electrode current collector sheet 11.

In the case of Embodiment 1, the positive-electrode active-material layer 12 is formed in the area excluding an outer periphery portion of both surfaces of the positive-electrode current collector sheet 11. Accordingly, the positive-electrode current collector sheet 11 has a peripheral area 11a (hereinafter sometimes referred to as a “positive-electrode non-coated portion 11a”) having a quadrangular frame shape in which the positive-electrode active-material layer 12 is not formed.

The width of the positive-electrode non-coated portion 11a is not particularly limited. However, if the width becomes large, the amount of the active material becomes relatively small compared to the outer shape of the battery, and the amount of energy that can be stored per unit volume becomes small. Therefore, the width is to be, for example, from about 2 to 10 mm.

The negative-electrode plate 20 has a rectangular negative-electrode current collector sheet 21 that is larger than the positive-electrode current collector sheet 11, and a negative-electrode active-material layer 22 laminated in a rectangular shape in the active material formation region of both surfaces of the negative-electrode current collector sheet 21.

In the case of Embodiment 1, the negative-electrode active-material layer 22 is formed in the peripheral area excluding two short sides that are opposite to each other on both surfaces of the negative-electrode current collector sheet 21 and with the size larger than the positive-electrode active-material layer 12. Accordingly, the negative-electrode current collector sheet 21 has a line-shaped peripheral area 21a (hereinafter sometimes referred to as a “negative-electrode non-coated portion 21a”) in which the negative-electrode active-material layer 22 is not formed.

The width of the positive-electrode non-coated portion 21a is not particularly limited. However, as in the case of the positive electrode, if the width becomes large, the amount of the active material becomes relatively small compared to the outer shape of the battery, and the amount of energy that can be stored per unit volume becomes small. Therefore, the width is to be, for example, from about 2 to 10 mm.

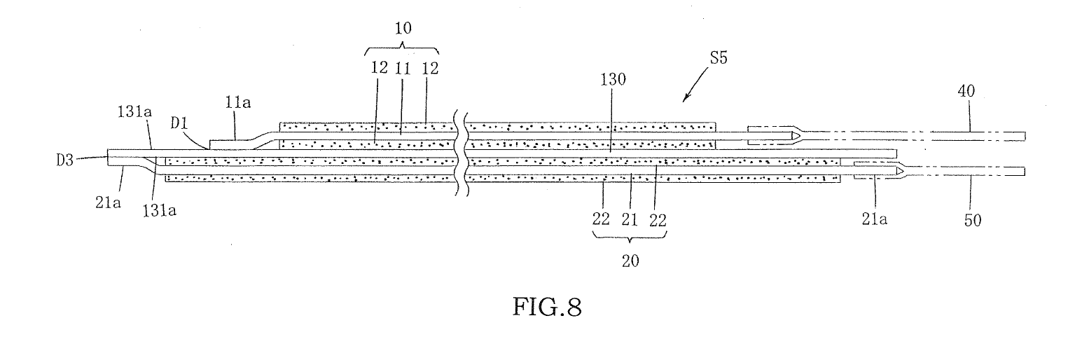

The positive-electrode lead plate 40 is a metal band plate made of a material similar to that of the positive-electrode current collector sheet 11, and is bonded, for example, in such a manner that both ends of the folded metal band plate sandwich one short side of the positive-electrode current collector sheet 11 (see FIG. 8).

The negative-electrode lead plate 50 is a metal band plate made of a material similar to that of the negative-electrode current collector sheet 21, and is bonded, for example, in such a manner that both ends of the folded metal band plate sandwich one short side of the negative-electrode current collector sheet 21 (see FIG. 8).

In Embodiment 1, the positive-electrode lead plate 40 and the negative-electrode lead plate 50 are disposed on the side of the same side of a rectangle and at different positions. However, they may be disposed on the sides of two sides that are opposite to each other.

The positive-electrode terminal plate 41 is made up of two metal plates made of a material similar to that of the positive-electrode lead plate 40, which allows the positive-electrode lead plate 40 to be bonded in such a manner that the positive-electrode lead plate 40 is sandwiched by the two metal plates.

The negative-electrode terminal plate 51 is made up of two metal plates made of a material similar to that of the negative-electrode lead plate 50, which allows the negative-electrode lead plate 50 to be bonded in such a manner that the negative-electrode lead plate 50 is sandwiched by the two metal plates.

Note that bonding of the lead plates 40 and 50 to the current collector sheets 11 and 21 in the respective electrodes and bonding of the terminal plates 41 and 51 to the lead plates 40 and 50 in the respective electrodes can be carried out by, for example, cold crimping (including calking), riveting, ultrasonic welding, resistance welding, laser beam welding or the like.

The separator 30 has a sheet-like first separator 31 formed in a rectangular shape and a size equal to or larger than that of the negative-electrode current collector sheet 21, and a sheet-like second separator 32 formed in a rectangular shape and a size equal to that of the first separator.

The positive-electrode plate 10 and the negative-electrode plate 20 are bonded to the peripheral areas of both surfaces of the first separator 31. By this means, the first separator 31 maintains a state in which the whole area of the positive-electrode active-material layer 12 overlaps the area of the negative-electrode active-material layer 22, and has a function of preventing physical and electrical contact of the positive-electrode plate 10 and the negative-electrode plate 20.

In the case where a plurality of battery modules S1 in which the positive-electrode plate 10 and the negative-electrode plate 20 are bonded to both surfaces of the first separator 31 are stacked in the covering material 60, the second separator 32 has functions of preventing the positive-electrode plate of one battery module and the negative-electrode plate of another battery module adjacent thereto from coming into physical and electrical contact with each other, and of containing and pressing the positive-electrode plate 10.

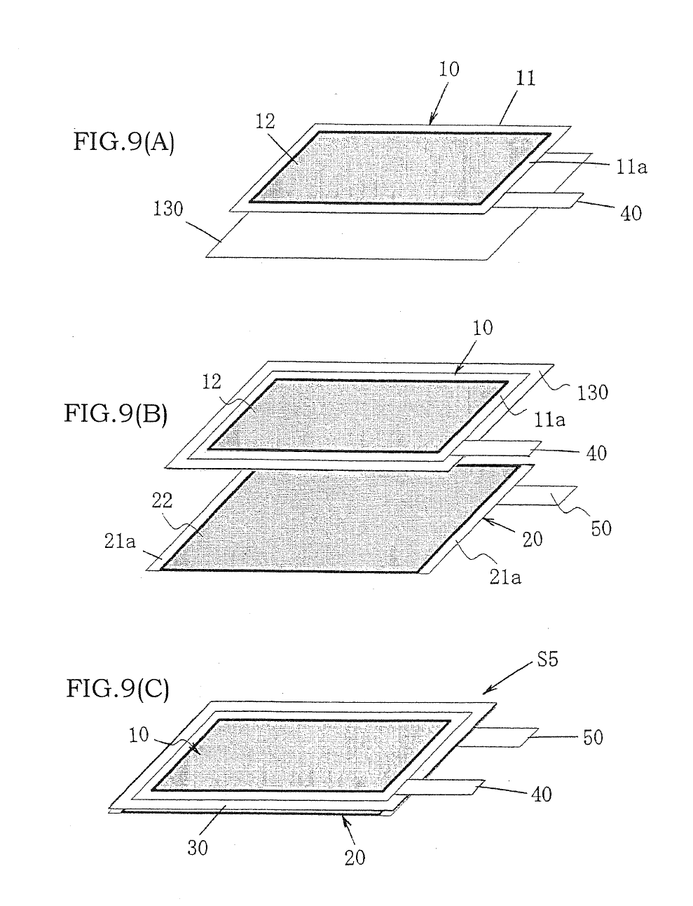

Therefore, in the case of one battery module S1 as in Embodiment 1, the second separator 32 can be omitted (see FIGS. 8 and 9(A) to 9(C)). Further, the outer positive-electrode active-material layer 12 and the outer negative-electrode active-material layer 22 do not contribute to power generation, and therefore these can also be omitted.

Next, a method of manufacturing the flat secondary battery of Embodiment 1 is described, such that the above-mentioned bonded form is described more specifically.

This flat secondary battery can be manufactured by a manufacturing method that includes the steps of (A) laminating the positive-electrode active-material layer 12 on a non-bonding area, which does not bond to a separator, of one surface or both surfaces of the positive-electrode current collector sheet 11 to form the positive-electrode plate 10, and attaching the positive-electrode lead plate 40 to the positive-electrode current collector sheet 11, (B) laminating the negative-electrode active-material layer 22 on a non-bonding area, which does not bond to the separator, of one surface or both surfaces of the negative-electrode current collector sheet 21 to form the negative-electrode plate 20, and attaching the negative-electrode lead plate 50 to the negative-electrode current collector sheet 21, (C) bonding a bonding area in a peripheral area of the positive-electrode current collector sheet 21 and the negative-electrode current collector sheet 21 each to peripheral areas of both surfaces of the separator (the first separator 31) to form a battery module, and (D) enclosing the battery module in the covering material 60 having an electrolytic solution inlet in a state to expose an end of the lead plates 40 and 50 to the outside of the covering material, injecting an electrolytic solution into the covering material 60 through the electrolytic solution inlet, and sealing the electrolytic solution inlet.

FIGS. 3(A) to 3(E) each show a process of forming a battery module in the above-mentioned step (C).

In the case of Embodiment 1, in the above-mentioned step (C), as shown in FIG. 3(A), the positive-electrode non-coated portion 11a of one surface of the positive-electrode current collector sheet 21, which has on both surfaces thereof the positive-electrode active-material layer 12, is bonded to a peripheral area 31a of one surface of the first separator 31.

At this point, as described above, the positive-electrode current collector sheet 11 is made of a metal sheet or a conductive composite sheet having a metal film on the surface of a resin film, and the separator 30 is made of a synthetic resin, and therefore, as a method of bonding these components, ultrasonic welding, heat fusion, or thermo-compression bonding can be used. Preferably, a metal film of the positive-electrode non-coated portion 11a of the conductive composite sheet is removed to expose a resin film, or an exposed portion of a resin film where a metal film is not formed is left at the time of forming a conductive composite sheet, and a resin film and the first separator 31 are bonded to form a bonded portion such that resins are bonded to each other to increase bonding strength.

It should be noted that, in FIG. 2, symbol D1 denotes a bonded portion of the positive-electrode current collector sheet 11 and the first separator 31.

The positive-electrode plate 10 is smaller than the first separator 31, and therefore the peripheral area 31a that does not overlap the positive-electrode plate 10 is exposed on one surface of the first separator 31.

Next, as shown in FIG. 3(B), the peripheral area of the second separator 32 is bonded to the peripheral area 31a of the first separator 31 in such a manner as to cover the positive-electrode plate 10. At this point, ultrasonic welding, heat fusion, or thermo-compression bonding can also be used. It should be noted that, in FIG. 2, symbol D2 denotes a bonded portion of the first separator 31 and the second separator 32.

In this way, the bag-like separator 30 is formed with the first and second separators 21 and 32, and results in a state in which the positive-electrode plate 10 is contained in the bag-like separator 30 so as to prevent a movement of the positive-electrode plate 10.

Next, as shown in FIGS. 3(C) to 3(E), two non-coated portions 21a of one surface of the negative-electrode current collector sheet 21, which has on both surfaces thereof the negative-electrode active-material layer 22, are bonded to the peripheral area of the other surface of the first separator 31, so that the battery module S1 is completed.

At this point, as described above, the negative-electrode current collector sheet 21 is made of a metal sheet or a composite sheet having a metal film on the surface of a resin film, and the separator 30 is made of a synthetic resin, and therefore, as a method of bonding these components, ultrasonic welding, heat fusion, or thermo-compression bonding can be used. Preferably, a metal film of the negative-electrode non-coated portion 21a of the composite sheet is removed to expose a resin film, and the resin film and the first separator 31 are bonded to each other, which is bonding between resins and therefore bonding strength can be increased. It should be noted that, in FIG. 2, symbol D3 denotes a bonded portion of the negative-electrode current collector sheet 21 and the first separator 31.

Thereafter, in the above-mentioned step (D), the formed battery module S1 with leading ends of the positive and negative lead plates 40 and 50 being exposed outside is enclosed into the inside of the covering material 60, the positive-electrode terminal plate 41 and the negative-electrode terminal plate 51 are attached to the positive-electrode lead plate 40 and the negative-electrode lead plate 50, an electrolytic solution is injected into the inside, and sealing is made, so that a flat secondary battery is completed.

The flat secondary battery manufactured in this way is maintained in a state where the outer periphery portion 11a of the positive-electrode current collector sheet 11 and two sides of the peripheral area of the negative-electrode current collector sheet 21 are bonded to the first separator 31, and the whole area of the positive-electrode active-material layer 12 overlaps the area of the negative-electrode active-material layer 22 with the first separator 31 therebetween.

Accordingly, even if the flat secondary battery receives a vibration and an impact from the outside, the flat secondary battery is prevented from internal short-circuiting that occurs when damage to the bag-like separator 30 is caused by a pointed corner of the positive-electrode current collector sheet 11 to bring the positive-electrode plate 10 and the negative-electrode plate 20 into contact with each other. Moreover, the positive-electrode active-material layer 12 and the negative-electrode active-material layer 22 that are opposite to each other cannot move with respect to the first separator 31, and therefore no part of the area of the positive-electrode active-material layer 12 protrudes outside the area of the negative-electrode active-material layer 22. Thus, formation of dendrites due to metal deposition in the negative-electrode current collector sheet and a capacitance decrease resulting therefrom are prevented, and further internal short-circuiting resulting from damage to the separator that is caused by the dendrites is prevented.

Note that the process of forming the battery module S1 is not limited to the order shown in FIGS. 3(A) to 3(E). For example, after the first separator 31 and the negative-electrode plate 20 are bonded, the first separator 31 and the positive-electrode plate 10 may be bonded. Also, before the second separator 32 is bonded to the first separator 31, the negative-electrode plate 20 may be bonded to the first separator 31.

### Embodiment 2

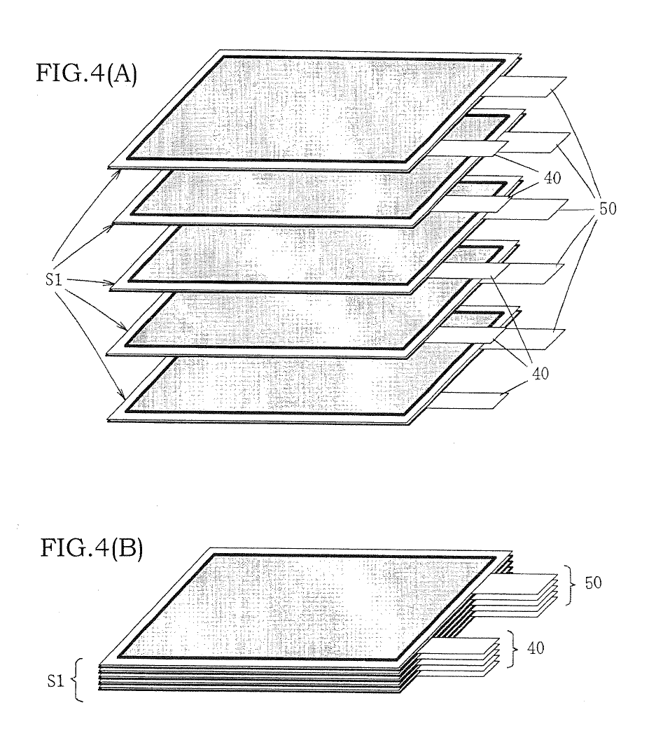

FIGS. 4(A) and 4(B) are process explanatory views each showing part of a process of manufacturing a flat secondary battery in Embodiment 2 of the present invention.

Embodiment 2 is a flat secondary battery in which a plurality of (e.g., five) battery modules S1 of Embodiment 1 shown in FIGS. 2 and 3 are included. It should be noted that, in FIG. 4, the same elements as those of Embodiment 1 shown in FIGS. 2 and 3 are denoted by the same symbols. Hereinafter, the configuration in Embodiment 2 that is different from that in Embodiment 1 is mainly described.

In the case of Embodiment 2, in the above-mentioned step (C), as shown in FIG. 4(A), a plurality of battery modules S1 are formed for one flat secondary battery. As shown in FIG. 4(B), in a state where the plurality of battery modules S1 are mutually stacked, a plurality of lead plates of the positive electrodes are mutually stacked, sandwiched by the positive-electrode terminal plates, and bonded, and a plurality of lead plates of the negative electrode are mutually stacked, sandwiched by the negative-electrode terminal plates, and bonded.

At this point, the plurality of battery modules S1 are stacked such that the second separator 32 of one battery module S1 is in contact with the outer negative-electrode active-material layer 22 of another battery module S1 adjacent thereto.

In the above-mentioned step (D), the plurality of battery modules S1 being stacked are enclosed into the inside of the covering material 60 (see FIG. 1), an electrolytic solution is injected into the inside, and sealing is made, so that a flat secondary battery (stacked secondary battery) is completed.

In the flat secondary battery formed in this way, as in Embodiment 1, each battery module S1 is maintained in a state where the outer periphery portion 11a of the positive-electrode current collector sheet 11 of the positive-electrode plate 10 and two sides of the peripheral area of the negative-electrode current collector sheet 21 of the negative-electrode plate 20 are bonded to the first separator 31, and the whole area of the positive-electrode active-material layer 12 of the positive-electrode plate 10 overlaps the area of the negative-electrode active-material layer 22 of the negative-electrode plate 20 with the first separator 31 therebetween.

A plurality of battery modules S1 are combined into a single unit with the positive-electrode terminal plates and the negative-electrode terminal plates.

Accordingly, in each battery module S1, as in Embodiment 1, even if the flat secondary battery receives a vibration and an impact from the outside, the flat secondary battery is prevented from internal short-circuiting that occurs when damage to the bag-like separator 30 is caused by a pointed corner of the positive-electrode current collector sheet 11 to bring the positive-electrode plate 10 and the negative-electrode plate 20 into contact with each other. Moreover, the positive-electrode active-material layer 12 and the negative-electrode active-material layer 22 that are opposite to each other cannot move with respect to the first separator 31, and therefore no part of the area of the positive-electrode active-material layer 12 protrudes outside the area of the negative-electrode active-material layer 22. Thus, formation of dendrites due to metal deposition in the negative-electrode current collector sheet and a capacitance decrease resulting therefrom are prevented, and further internal short-circuiting resulting from damage to the separator that is caused by the dendrites is prevented.

Moreover, the plurality of battery modules S1 are combined into a single unit, and therefore relative movements and position shifts of the battery modules S1 adjacent to one another are prevented. Precipitation of dendrites due to a position shift between two battery modules S1 adjacent to each other, and internal short-circuiting, which occurs along with it, are also prevented.

### Embodiment 3

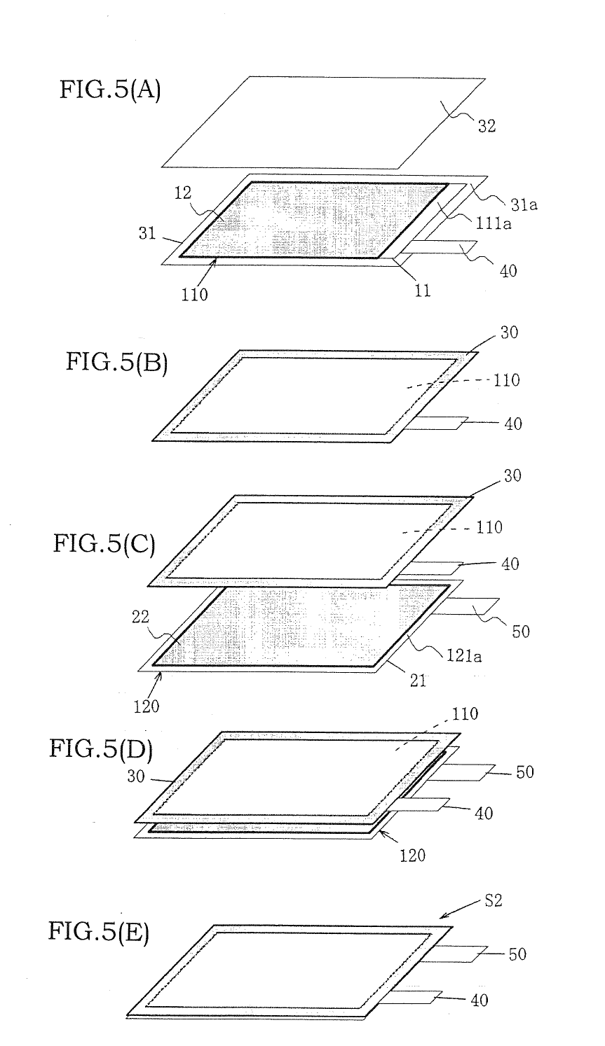

FIGS. 5(A) to 5(E) are process explanatory views each showing part of a process of manufacturing a flat secondary battery in Embodiment 3 of the present invention.

Embodiment 3 has a configuration similar to that of Embodiment 1 except that forms of bonded portions of a positive-electrode plate 110 and a negative-electrode plate 120 in a battery module S2 are different from those in Embodiment 1. It should be noted that, in FIG. 5, the same elements as those of Embodiment 1 shown in FIGS. 2 and 3 are denoted by the same symbols. Hereinafter, the configuration of points in Embodiment 3 that are different from those in Embodiment 1 is mainly described.

In the case of the battery module S2 of Embodiment 3, as shown in FIG. 5(A), the positive-electrode plate 110 has a positive-electrode non-coated portion 111a on both surfaces on the side of one short side of the positive-electrode current collector sheet 11, and the positive-electrode active-material layer 12 is formed in all the area excluding the positive-electrode non-coated portion 111a on both surfaces of the positive-electrode current collector sheet 11. The case in which the positive-electrode non-coated portion 111a is arranged on the side of the short side, to which the positive-electrode lead plate 40 is attached, in the positive-electrode current collector sheet 11 is illustrated in FIG. 5(A). However, the positive-electrode non-coated portion 111a may be arranged on the side of a short side without the positive-electrode lead plate 40, or on the side of one long side.

Also, as shown in FIG. 5(C), the negative-electrode plate 120 formed in a size larger than that of the positive-electrode active-material layer 12 has a negative-electrode non-coated portion 121a on both surfaces of the peripheral area of the negative-electrode current collector sheet 21. The negative-electrode active-material layer 22 is formed in all the area excluding the negative-electrode non-coated portion 121a on both surfaces of the negative-electrode current collector sheet 21 at a larger area than the positive-electrode active-material layer 12.

In this case, the width of the positive-electrode non-coated portion 111a is suitably from about 5 to 10 mm, and the width of the negative-electrode non-coated portion 121a is suitably from about 1 to 8 mm.

The battery module S2 of Embodiment 3 can be formed as follows.

Initially, as shown in FIG. 5(A), the positive-electrode non-coated portion 111a on the side of one surface of the positive-electrode current collector sheet 11 is bonded to the first separator 31. At this point, the peripheral area 31a of the first separator 31 that does not overlap the positive-electrode plate 110 is exposed.

Next, as shown in FIG. 5(B), as in Embodiment 1, the peripheral area of the second separator 32 is bonded to the peripheral area 31a of the first separator 31, so that the bag-like separator 30 is formed.

Next, as shown in FIGS. 5(C) to 5(E), the peripheral area of the first separator 31 of the separator 30 having the positive-electrode plate 110 contained inside thereof is bonded to the negative-electrode non-coated portion 121a of the negative-electrode plate 120, and thus the battery module S2 of Embodiment 3 is completed.

In the flat secondary battery of Embodiment 3, the positive-electrode plate 110 has one bonded portion. However, the whole positive-electrode plate 110 is contained within the bag-like separator 30 and is sandwiched by the first and second separators 31 and 32, and therefore the positive-electrode plate 110 does not shift with respect to the negative-electrode plate 120 in the bag-like separator 30.

Note that, in Embodiment 3, like in Embodiment 1, there is provided one battery module S2, and therefore the second separator 32 can be omitted (see FIGS. 8 and 9). Further, the outer positive-electrode active-material layer 12 and the outer negative-electrode active-material layer 22 do not contribute to power generation, and therefore these can also be omitted.

### Embodiment 4

A flat secondary battery (not shown) of Embodiment 4 includes a plurality of batteries S2 of Embodiment 3, each of which is described with reference to FIG. 5, in such a manner that they are stacked. Note that, in Embodiment 4, steps after forming a battery module can be performed according to Embodiment 3.

### Embodiment 5

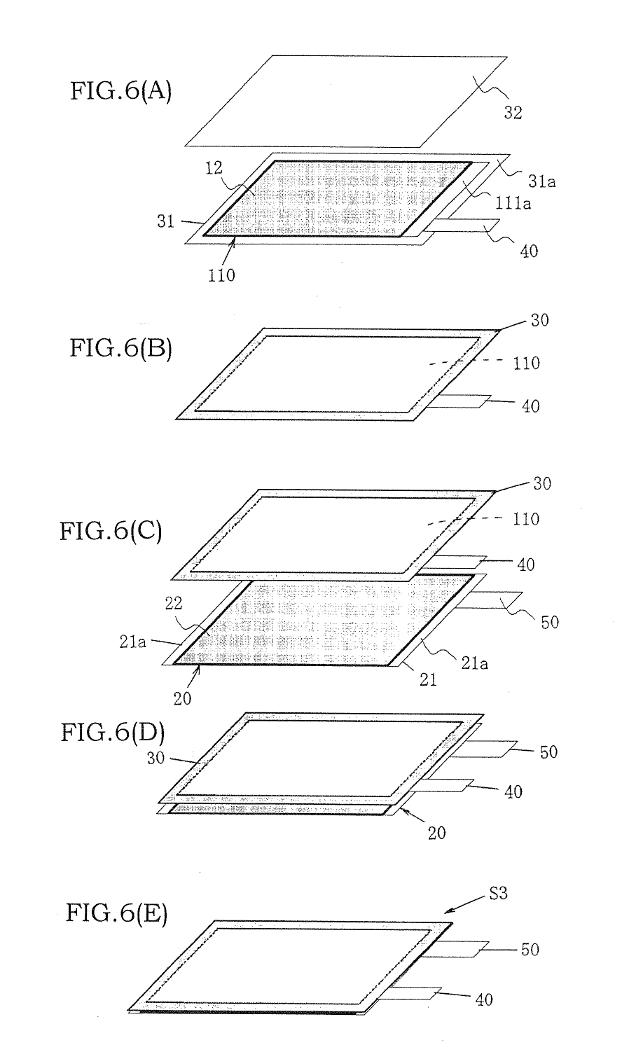

FIGS. 6(A) to 6(E) are process explanatory views each showing part of a process of manufacturing a flat secondary battery in Embodiment 5 of the present invention.

In a battery module S3 of Embodiment 5, the form of the bonded portion of the positive-electrode plate 110 is the same as that in Embodiment 3, and the form of the bonded portion of the negative-electrode plate 220 is the same as that in Embodiment 1, the bag-like shape of the separator 30 is the same as those in Embodiments 1 and 3. It should be noted that, in FIG. 6, the same elements as those of Embodiments 1 and 3 shown in FIGS. 3 and 5 are denoted by the same symbols.

In formation of the battery module S3 of Embodiment 5, steps shown in FIGS. 6(A) and 6(B) are similar to those in Embodiment 3 (FIGS. 5(A) and 5(B)), and steps shown in FIGS. 6(C) to 6(E) are similar to those in Embodiment 1 (FIGS. 3(C) to 6(E)).

In Embodiment 5, like in Embodiment 1, there is provided one battery module S3, and therefore the second separator 32 can be omitted (see FIGS. 8 and 9). Further, the outer positive-electrode active-material layer 12 and the outer negative-electrode active-material layer 22 do not contribute to power generation, and therefore these can also be omitted.

### Embodiment 6

A flat secondary battery (not shown) of Embodiment 6 includes a plurality of batteries S3 of Embodiment 5, each of which is described with reference to FIG. 6, in such a manner that they are stacked. Note that, in Embodiment 6, steps after forming a battery module can be performed according to Embodiment 3.

### Embodiment 7

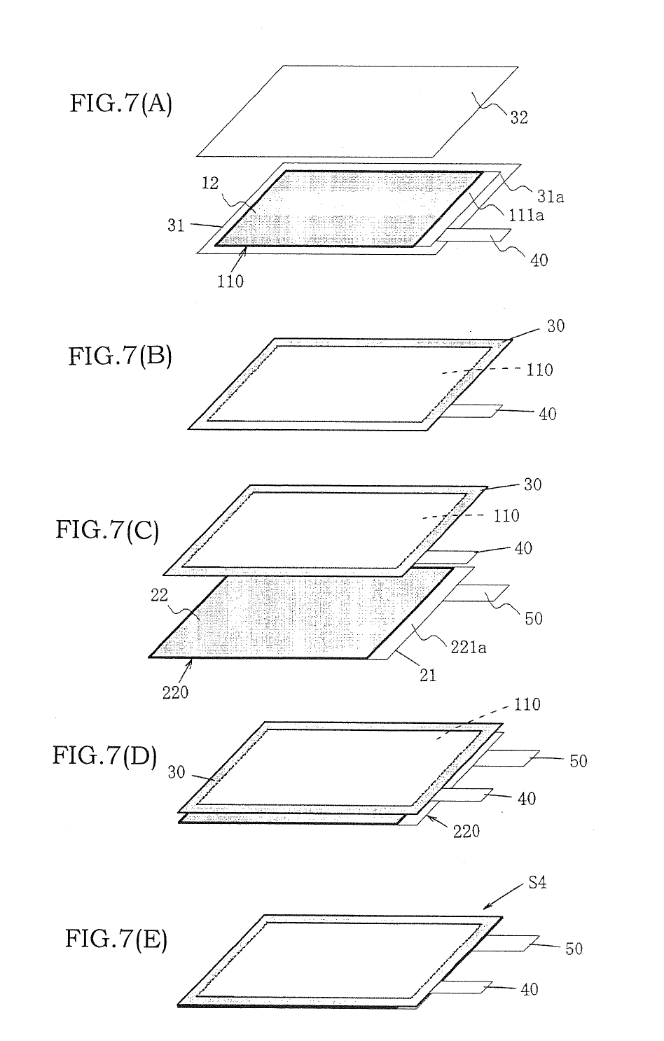

FIGS. 7(A) to 7(E) are process explanatory views each showing part of a process of manufacturing a flat secondary battery in Embodiment 7 of the present invention. It should be noted that, in FIG. 7, the same elements as those of Embodiments 1, 3 and 5 shown in FIGS. 3, 5 and 6 are denoted by the same symbols.

In a battery module S4 of Embodiment 7, the form of the bonded portion of the positive-electrode plate 110 is the same as those in Embodiments 3 and 5, and the positive-electrode plate 110 has the positive-electrode non-coated portion 110a on both surfaces on the side of one short side (the side of the positive-electrode lead plate 40), and has the positive active material 12 in all the area excluding the positive-electrode non-coated portion 110a.

On the other hand, like the positive-electrode plate 110, the negative-electrode plate 220 has a negative-electrode non-coated portion 221a on both surfaces on the side of one short side (the side of the negative-electrode lead plate 50), and has the negative active material 22 in all the area excluding the negative-electrode non-coated portion 221a.

In this case, the negative-electrode active-material layer 22 is also formed in a size larger than the positive-electrode active-material layer 12, and the width of the negative-electrode non-coated portion 221a is suitably from about 2 to 8 mm.

Note that the bag-like shape of the separator 30 in Embodiment 7 is the same as in Embodiments 1, 3 and 5.

In formation of the battery module S4 of Embodiment 7, steps shown in FIGS. 7(A) and 7(B) are similar to those in Embodiment 3 (FIGS. 5(A) and 5(B)). In steps shown in FIGS. 7(C) to 7(E), the negative-electrode non-coated portion 221a of the negative-electrode plate 220 is bonded to the side of a short side of the first separator 31.

In Embodiment 7, like in Embodiment 1, there is provided one battery module S4, and therefore the second separator 32 can be omitted (see FIGS. 8 and 9). Further, the outer positive-electrode active-material layer 12 and the outer negative-electrode active-material layer 22 do not contribute to power generation, and therefore these can also be omitted.

### Embodiment 8

A flat secondary battery (not shown) of Embodiment 8 includes a plurality of batteries S4 of Embodiment 7, each of which is described with reference to FIG. 7, in such a manner that they are stacked. Note that, in Embodiment 8, steps after forming a battery module can be performed according to Embodiment 3.

### Embodiment 9

FIG. 8 is a schematic sectional view showing an internal laminated structure in a flat secondary battery of Embodiment 9. FIGS. 9(A) to 9(C) are process explanatory views each showing part of a process of manufacturing the flat secondary battery of Embodiment 8.

This laminated secondary battery is configured similarly to that of Embodiment 1 except that the second separator 32 in Embodiments 1 to 8 is omitted such that only the first separator 31 is included in the separator. It should be noted that, in FIGS. 8 and 9, the same elements as those shown in FIGS. 2 and 3 are denoted by the same symbols.

In formation of a battery module S5 of this flat secondary battery, as shown in FIG. 9(A), the quadrangular frame-shaped positive-electrode non-coated portion 11a of the positive-electrode plate 10 is bonded to a peripheral area 131a of one surface of a separator 130, and, as shown in FIGS. 9(B) and 9(C), the negative-electrode non-coated portions 21a on the sides of two short sides of the negative-electrode plate 20 are bonded to the peripheral area 131a of the other surface of the separator 130 bonded to the positive-electrode plate 10, so that the battery module S5 is completed.

Note that FIG. 8 shows a state in which the positive-electrode lead plate 40 is bonded to the positive-electrode non-coated portion 11a on the side of one side in the positive-electrode current collector sheet 11, and the negative-electrode lead plate 56 is bonded to the negative-electrode non-coated portion 21a on the side of one short side in the negative-electrode current collector sheet 21; however, portions not bonded to the lead plates 40 and 50 in the positive-electrode non-coated portion 11a and the negative-electrode non-coated portion 21a to which the lead plates 40 and 50 are bonded are bonded to an outer periphery portion 130a of the separator 130 as shown in the left part of FIG. 8.

In the case of the flat secondary battery of Embodiment 9, the separator 130 does not have such a bag-like shape as in Embodiment 1. However, there are effects equivalent to those of Embodiment 1.

In Embodiment 9, like in Embodiment 1, the outer positive-electrode active-material layer 12 and the outer negative-electrode active-material layer 22 do not contribute to power generation, and therefore these can also be omitted.

### Embodiment 10

A flat secondary battery (not shown) of Embodiment 10 includes a plurality of batteries S5 of Embodiment 9, each of which is described with reference to FIGS. 8 and 9, in such a manner that they are stacked.

In Embodiment 10, steps after forming the battery module S5 and attaching positive-electrode and negative-electrode terminal plates to the positive-electrode and negative-electrode lead plates 40 and 50 are that a plurality of battery modules S5 are stacked with the same separators as the separator 130 used for formation of the battery module S5, the battery modules S5 are enclosed into the inside of a covering material, an electrolytic solution is injected into the inside of the covering material, and sealing is made.

In the flat (stacked type) secondary battery of Embodiment 10 formed in this way, a separator disposed between the battery modules S5 is not bonded to the separator 130 of the adjacent battery module S5, and is in a free state. However, no problem is presented if the separator between the battery modules S5 is formed in a size sufficiently large to avoid contact between the positive-electrode plate 10 of one battery module S5 and the negative-electrode plate 20 of another battery module S5 adjacent thereto.

### Other Embodiments

In Embodiments 1 to 10, the case in which the bonded portion of the positive-electrode plate with the separator is substantially the entire periphery of the peripheral area, and the case in which the bonded portion is a portion of one short side of the peripheral area are exemplified, and the case in which the bonded portion of the negative-electrode plate with the separator is a portion of both short sides of the peripheral area, the case in which the bonded portion is substantially the entire periphery, and the case in which the bonded portion is one short side are exemplified. However, the bonded portions of the positive-electrode plate and the negative-electrode plate with the separator may be other than those in these cases. For example, a portion of one long side, a portion of one long side and a portion of one short side, portions of both long sides, the vicinities of two corners adjacent to each other, the vicinities of two corners opposite to each other, the vicinities of three corners or the vicinities of four corners may be used.

### EXAMPLES

### Example 1

A battery module having a structure shown in FIG. 6 was formed as follows.

A lithium cobaltate as a major component of a positive active material, a polyvinylidene fluoride as a carbon-based conductive material and a binder, and N-methylpyrrolidone were mixed and kneaded into paste, so that a kneaded mixture was obtained. The kneaded mixture was applied onto both surfaces of an aluminum foil of 15 cm in short side length, 20 cm in long side length and 20 μm in thickness, and was dried by heat at 140° C. for 20 min, and then was compression molded by a roll press, so that a positive-electrode plate with a total thickness of 100 μm was formed. At that point, a positive-electrode non-coated portion with a width of 1 cm was formed on the side of one short side of the positive-electrode plate.

A natural graphite as a negative active material, a polyvinylidene fluoride and N-methylpyrrolidone were mixed and kneaded into paste, so that a kneaded mixture was obtained. The kneaded mixture was applied onto both surfaces of a copper foil of 17 cm in short side length, 22 cm in long side length and 20 μm in thickness, and was dried by heat at 130° C. for 20 min, and then was compression molded by a roll press, so that a negative-electrode plate with a total thickness of 60 μm was formed. At that point, negative-electrode non-coated portions each having a width of 0.5 cm were formed on the sides of both short sides of the negative-electrode plate.

The positive-electrode non-coated portion of the positive-electrode plate was welded to the side of a short side of one surface of a first separator made of a polyethylene microporous film of 17 cm in short side length, 22 cm in long side length and 20 μm in thickness using a thermal technique, and the peripheral area of a second separator was welded to the peripheral area of the first separator with a width of 1 cm so as to cover the positive-electrode plate using a thermal technique, so that a bag-like separator was formed. Two negative-electrode non-coated portions of the negative-electrode plate were welded to two short sides of the other surface of the first separator using a thermal technique, so that a battery module was formed.

Five sets of the battery modules were formed. The sets of the battery modules in a state of being stacked were enclosed into a battery vessel (covering material). A positive-electrode terminal plate was attached to the positive-electrode lead plate of each battery module, and a negative-electrode terminal plate was attached to the negative-electrode lead plate of each battery module. An electrolytic solution was injected into the inside of the battery vessel, and sealing was made, so that a sealing test battery of Example 1 was formed.

Twenty batteries of Example 1 were formed, and a vibration test based on “the United Nations Regulations on the Transport of Li ion batteries” was conducted. Before and after the test, internal resistances of the batteries were measured, and the presence or absence of internal short-circuiting caused by breaking through the separator was checked. This time, a test using a battery that had been charged was not conducted. This was an action for preventing occurrence of phenomena such as heat generation and ignition that are caused by a heavy current flowing in the event of internal short-circuiting.

Accordingly, in the case in which the internal resistance of a battery before and after the test was 1 mΩ or less, the battery was evaluated to be “poor” as a product in which internal short-circuiting occurred. This result was represented in Table 1.

Note that the above-mentioned vibration test based on “the United Nations Regulations on the Transport of Li ion batteries” was conducted under the following specific conditions:

(1) apply vibration for 3 hours (total 9 hours) in each of the x-axis, y-axis and z-axis directions

(2) sweep a sine wave of from 5 Hz to 100 Hz

(3) set the acceleration in a variation width from 1 G to 8 G for 15 min per set.

### Example 2

Except that, in a battery module having a structure shown in FIG. 5, a negative-electrode plate was shaped to have a negative-electrode non-coated portion with a width of 0.5 cm in its outer periphery portion, and the whole negative-electrode non-coated portion is bonded to a first separator, twenty batteries of Example 2 were formed in a similar way to those in Example 1, and a vibration test similar to that in Example 1 was conducted. The test result was represented in Table 1.

### Example 3

Except that, in a battery module having a structure shown in FIG. 5, four corners of a negative-electrode non-coated portion of a peripheral area in the negative-electrode plate are bonded to a first separator, twenty batteries of Example 3 were formed in a similar way to those in Example 1, and a vibration test similar to that in Example 1 was conducted. The test result was represented in Table 1.

### Example 4

The flat secondary battery of Embodiment 10 as Example 4 was formed in similar procedures as those of Example 1.

A lithium cobaltate as a major component of a positive active material, a polyvinylidene fluoride as a carbon-based conductive material and a binder, and N-methylpyrrolidone were mixed and kneaded into paste, so that a kneaded mixture was obtained. The kneaded mixture was applied onto both surfaces of an aluminum foil of 15 cm in short side length, 20 cm in long side length and 20 μm in thickness, and was dried by heat at 140° C. for 20 min, and then was compression molded by a roll press, so that a positive-electrode plate with a total thickness of 100 μM was formed. At that point, a positive-electrode non-coated portion with a width of 1 cm was formed on the side of one short side of the positive-electrode plate.

A natural graphite as a negative active material, a polyvinylidene fluoride and N-methylpyrrolidone were mixed and kneaded into paste, so that a kneaded mixture was obtained. The kneaded mixture was applied onto both surfaces of a copper foil of 17 cm in short side length, 22 cm in long side length and 20 μm in thickness, and was dried by heat at 130° C. for 20 min, and then was compression molded by a roll press, so that a negative-electrode plate with a total thickness of 60 μm was formed. At that point, negative-electrode non-coated portions each having a width of 0.5 cm were formed on the sides of both short sides of the negative-electrode plate.

The positive-electrode non-coated portion of the positive-electrode plate was welded to a short side of one surface of a first separator made of a polyethylene microporous film of 17 cm in short side length, 22 cm in long side length and 20 μm in thickness using a thermal technique, and two negative-electrode non-coated portions of the negative-electrode plate were welded to two short sides of the other surface of the first separator using a thermal technique, so that a battery module was formed (FIG. 8).

Five sets of the battery modules were formed. The sets of the battery modules in a state of being stacked, such that a second separator having an outer shape larger than the first separator was disposed between the positive electrode and the negative electrode, were enclosed into a battery vessel (covering material). A positive-electrode terminal plate was attached to the positive-electrode lead plate of each battery module, and a negative-electrode terminal plate was attached to the negative-electrode lead plate of each battery module. An electrolytic solution was injected into the inside of the battery vessel, and sealing was made, so that a sealing test battery of Example 4 was formed. Twenty sealing test batteries of Example 4 were formed, and like Example 1, a vibration test based on “the United Nations Regulations on the Transport of Li ion batteries” was conducted. Before and after the test, internal resistances of the batteries were measured, and the presence or absence of internal short-circuiting was checked. Accordingly, in the case in which the internal resistance of a battery before and after the test was 1 mΩ or less, the battery was evaluated to be “poor” as a product in which internal short-circuiting occurred. This result was represented in Table 1.

### Comparative Example 1

Except that, in a battery module having a structure shown in FIG. 5, a negative-electrode plate is not bonded to a separator in which a positive-electrode plate is packed, twenty batteries of Comparative Example 1 were formed in a similar way to those in Example 1, and a vibration test similar to that in Example 1 was conducted. The test result was represented in Table 1.

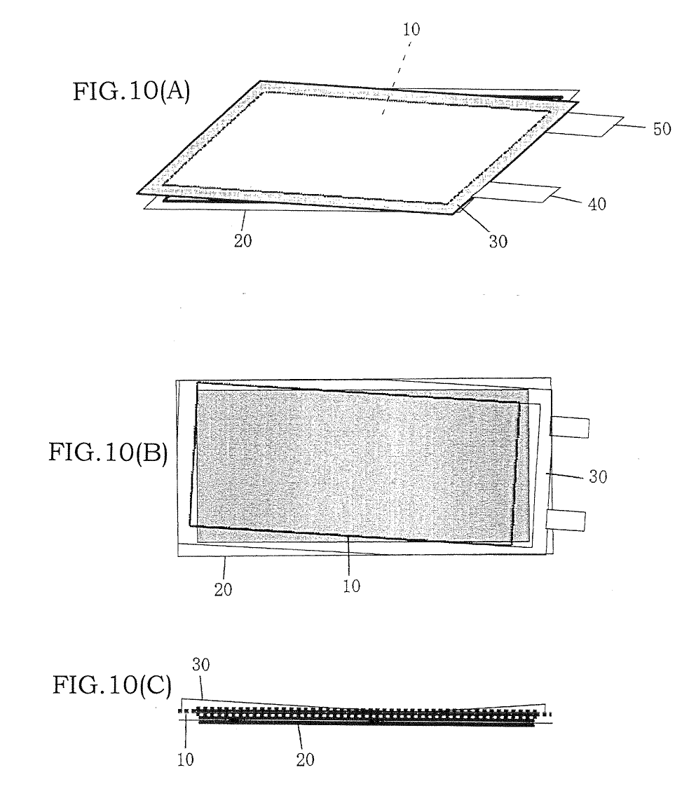

How the positions of electrodes inside the battery of Comparative Example 1 had changed after the test was resolved, and schematic views thereof were shown as a perspective view of FIG. 10(A), a top perspective view of FIG. 10(B) and a side view of FIG. 10(C).

TABLE 1

| | Example | Example | Example | Example | Comparative |
|---|---|---|---|---|---|
| | 1 | 2 | 3 | 4 | Example 1 |
| The number of | 0 | 0 | 0 | 0 | 9 |
| short-circuiting | | | | | |
| occurred | | | | | |
| Rate of | 0 | 0 | 0 | 0 | 45 |
| short-circuiting | | | | | |
| occurred | | | | | |

From Table 1, it was confirmed that as compared to Comparative Example 1, Examples 1 to 3 had no short-circuiting, and this problem was dissolved. Also, in the case of Example 4, the outer shape of the second separator was sufficiently larger than the outer shape of the first separator, and therefore the amount of the active material became relatively small compared to the outer shape of the battery, and the amount of energy that could be stored per unit volume became small. However, it was confirmed that the battery module moved in the battery vessel, and no short-circuiting occurred. On the other hand, in the case of Comparative Example 1, as shown in FIG. 10, it was found that the positive-electrode plate 10 moved together with the bag-like separator 30 inside the battery vessel, the separator 30 was raised along the inner wall of the vessel to shift to such an extent that a corner of the positive-electrode plate 10 rubbed against the vessel and the negative-electrode plate 20, so that the positive-electrode plate 10 damaged the separator 30, which was a cause of short-circuiting.

Note that except that, in a battery module having a structure shown in FIG. 7, a negative-electrode non-coated portion on the side of one short side in a negative-electrode plate is bonded to a first separator, twenty batteries were formed in a similar way to those in Example 2, and a vibration test similar to that in Example 1 was conducted. It was confirmed that while short-circuiting occurred, the short-circuiting was reduced to be smaller than Comparative Example 1.

### DESCRIPTION OF SYMBOLS

10, 110 Positive-Electrode Plate
11 Positive-Electrode Current Collector Sheet
11a, 111a Positive-Electrode Non-Coated Portion
12 Positive-electrode active-material layer
20, 120, 220 Negative-Electrode Plate
21 Negative-Electrode Current Collector Sheet
21a, 121a, 221a Negative-Electrode Non-Coated Portion
22 Negative-electrode active-material layer
30, 130 Separator
31a, 131a Peripheral Area
31 First Separator
32 Second Separator
40 Positive-Electrode Lead Plate
41 Positive-Electrode Terminal Plate
50 Negative-Electrode Lead Plate
51 Negative-Electrode Terminal Plate
60 Covering Material (Battery Vessel)
D1, D2, D3 Bonded Portion
S1, S2, S3, S4, S5 Battery Module

1. A flat secondary battery comprising:
a positive electrode plate;
a negative electrode plate opposed to the positive electrode plate;
an electrolytic solution being present between the electrode plates;
a separator interposed between the electrode plates; and
a covering material for sealing the electrolytic solution,
wherein the positive electrode plate includes: a positive-electrode current-collector sheet whose peripheral area has a bonding area bonded to a peripheral area of the separator; and a positive-electrode active-material layer laminated on a non-bonding area of one surface or both surfaces of the positive-electrode current-collector sheet,
the negative-electrode plate includes: a negative-electrode current-collector sheet whose peripheral area has a bonding area bonded to the peripheral area of the separator; and a negative-electrode active-material layer laminated on a non-bonding area of one surface or both surfaces of the negative-electrode current-collector sheet and having a sufficient size to cover the positive-electrode active-material layer, and
the peripheral areas of both surfaces of the separator are bonded to the bonding areas of the positive-electrode current-collector sheet and the negative-electrode current-collector sheet to maintain a state in which an area of the negative-electrode active-material layer entirely covers an area of the positive-electrode active-material layer so that a battery module is formed.

2. The flat secondary battery according to claim 1, wherein the positive-electrode current-collector sheet and the negative-electrode current collector sheet each have plural bonding areas.

3. The flat secondary battery according to claim 1, wherein
the positive-electrode current-collector sheet, the negative-electrode current-collector sheet, and the separator each are quadrangular,
the peripheral area of the positive-electrode current-collector sheet and the peripheral area of the separator are bonded to each other at one side thereof, at two sides thereof opposite to each other, at two or more sides thereof adjacent to one another, in the vicinity of two corners thereof opposite to each other, or in the vicinity of three or more corners thereof, and
the peripheral area of the negative-electrode current-collector sheet and the peripheral area of the separator are bonded to each other at one side thereof, at two sides thereof opposite to each other, at two or more sides thereof adjacent to one another, in the vicinity of two corners thereof opposite to each other, or in the vicinity of three or more corners thereof.

4. The flat secondary battery according to claim 3, wherein
the negative-electrode current-collector sheet is formed in a size larger than the positive-electrode current-collector sheet, and
the separator is formed in a size equal to the negative-electrode current-collector sheet.

5. The flat secondary battery according to claim 1, wherein
the positive-electrode current-collector sheet and the negative-electrode current-collector sheet each are made of a conductive sheet where at least its surface is metal,
the separator is made of a resin material, and
the separator is bonded to the positive-electrode current-collector sheet and the negative-electrode current-collector sheet by ultrasonic welding, heat fusion, or thermo-compression bonding.

6. The flat secondary battery according to claim 5, wherein
the positive-electrode current-collector sheet and the negative-electrode current-collector sheet each comprise: a resin film made of at least one kind of a resin material selected from polypropylene, polyethylene, polyethylene terephthalate, nylon, polyamide and polyimide; and a metal film laminated on a surface of the resin film, and
the resin film of the positive-electrode current-collector sheet and the negative-electrode current-collector sheet each is bonded to the separator.

7. The flat secondary battery according to claim 4, wherein
the separator is in the form of a bag and contains: a first separator bonded to the positive-electrode current-collector sheet and the negative-electrode current-collector sheet; and a second separator bonded to a peripheral area of one surface of the first separator,
the positive-electrode current-collector sheet is bonded to one surface of the first separator in the bag-like separator, and
the negative-electrode current-collector sheet is bonded to another surface of the first separator.

8. The flat secondary battery according to claim 7, wherein
the positive electrode plate has the positive-electrode active-material layer on both surfaces of the positive-electrode current-collector sheet, and the negative electrode plate has the negative-electrode active-material layer on both surfaces of the negative-electrode current-collector sheet,
the battery module is formed by bonding the positive-electrode current-collector sheet of the positive electrode plate to the one surface of the first separator in the bag-like separator, and bonding the negative-electrode current-collector sheet of the negative electrode plate to the another surface of the first separator, and
a plurality of such battery modules are stacked on one another in the covering material.

9. The flat secondary battery according to claim 1, wherein a plurality of battery modules are stacked on one another in the covering material.

10. A method of manufacturing a flat secondary battery, comprising the steps of:
(A) laminating a positive-electrode active-material layer on a non-bonding area, which does not bond to a separator, of one surface or both surfaces of a positive-electrode current-collector sheet to form a positive electrode plate, and attaching a lead plate to the positive-electrode current-collector sheet;
(B) laminating a negative-electrode active-material layer on a non-bonding area, which does not bond to the separator, of one surface or both surfaces of a negative-electrode current-collector sheet to form a negative electrode plate, and attaching a lead plate to the negative-electrode current-collector sheet;
(C) bonding a bonding area in a peripheral area of the positive-electrode current-collector sheet and the negative-electrode current-collector sheet each to peripheral areas of both surfaces of the separator to form a battery module; and
(D) enclosing the battery module in a covering material having an electrolytic solution inlet in a state to expose an end of each lead plate to the outside of the covering material, injecting an electrolytic solution into the covering material through the electrolytic solution inlet, and sealing the electrolytic solution inlet.

11. The method according to claim 10, wherein
in step (A), the positive-electrode active-material layer is laminated on the non-bonding area of each of the both surfaces of the positive-electrode current-collector sheet to form the positive electrode plate,
in step (B), the negative-electrode active-material layer is laminated on the non-bonding area of each of the both surfaces of the negative-electrode current-collector sheet to form the negative electrode plate,
step (C) includes the steps of: bonding the positive-electrode current-collector sheet to a peripheral area of one surface of a first separator and bonding a second separator to the peripheral area of the first separator to cover the positive electrode plate; and bonding the negative-electrode current-collector sheet to a peripheral area of another surface of the first separator, so as to form a plurality of battery modules, and
in step (D), the plurality of battery modules stacked on one another are enclosed in the covering material.

12. The method according to claim 10, wherein, in step (C), the separator is bonded to the positive-electrode current-collector sheet and the negative-electrode current-collector sheet by ultrasonic welding, heat fusion, or thermo-compression bonding.
